(19) United States
(12) Patent Application Publication
(10) Pub. No.: US 2016/0306357 A1
(43) Pub. Date: Oct. 20, 2016

(54) AUTOMATED VEHICLE SYSTEM WITH POSITION BIAS FOR MOTORCYCLE LANE SPLITTING

(71) Applicant: DELPHI TECHNOLOGIES, INC., Troy, MI (US)

(72) Inventors: JONATHAN L. WIESKAMP, SUNNYVALE, CA (US); MICHAEL H. LAUR, MISSION VIEJO, CA (US)

(21) Appl. No.: 14/689,250

(22) Filed: Apr. 17, 2015

(51) Int. Cl. G05D 1/02; B62D 15/02; G08G 1/16

(52) U.S. Cl. CPC G05D 1/0214; G08G 1/162; B62D 15/0265; G05D 2201/0213

(57) ABSTRACT

A system for automated operation of a host-vehicle includes a lane-splitting-motorcycle detector and a controller. The lane-splitting-motorcycle detector is configured to determine when a motorcycle proximate to a host-vehicle is traveling proximate to a lane-boundary adjacent the host-vehicle. The controller is configured to, during automated operation, steer the host-vehicle away from the lane-boundary to a biased-position selected to provide clearance for the motorcycle to pass the host-vehicle while the motorcycle is lane-splitting.

### TECHNICAL FIELD OF INVENTION

This disclosure generally relates to a system for automated operation of a host-vehicle, and more particularly relates to automated steering of the host-vehicle away from a lane-boundary to provide clearance for a motorcycle, bicycle, or other narrow vehicle to pass the host-vehicle while engaged in lane-splitting, i.e. traveling on the lane-boundary.

### BACKGROUND OF INVENTION

The operation of modern vehicles is becoming more autonomous, i.e., the vehicles are able to provide driving control with less driver intervention. In some jurisdictions (e.g. California) motorcycles are allowed to “lane split” or pass between adjacent vehicles in adjacent lanes. In order to protect motorcyclists and avoid accidents, many drivers steer or bias away from the lane-boundary that lane splitting motorcycles follow when the drivers see or hear a motorcycle approaching. Prior automated vehicle systems that operate without substantive input from occupants present in the automated vehicle are configured to steer the vehicle toward a centered-position of the travel-lane that the automated vehicle travels upon.

### SUMMARY OF THE INVENTION

In accordance with one embodiment, a system for automated operation of a host-vehicle is provided. The system includes a lane-splitting-motorcycle detector and a controller. The lane-splitting-motorcycle detector is configured to determine when a motorcycle proximate to a host-vehicle is traveling proximate to a lane-boundary adjacent the host-vehicle. The controller is configured to, during automated operation, steer the host-vehicle away from the lane-boundary to a biased-position selected to provide clearance for the motorcycle to pass the host-vehicle while the motorcycle is lane-splitting.

Further features and advantages will appear more clearly on a reading of the following detailed description of the preferred embodiment, which is given by way of non-limiting example only and with reference to the accompanying drawings.

### BRIEF DESCRIPTION OF DRAWINGS

The present invention will now be described, by way of example with reference to the accompanying drawings, in which:

FIG. 1 is a top view of a multi-lane roadway traveled by an automated vehicle equipped with a system to detect a lane splitting motorcycle in accordance with one embodiment; and

FIG. 2 is a diagram of the system of FIG. 1 in accordance with one embodiment.

### DETAILED DESCRIPTION

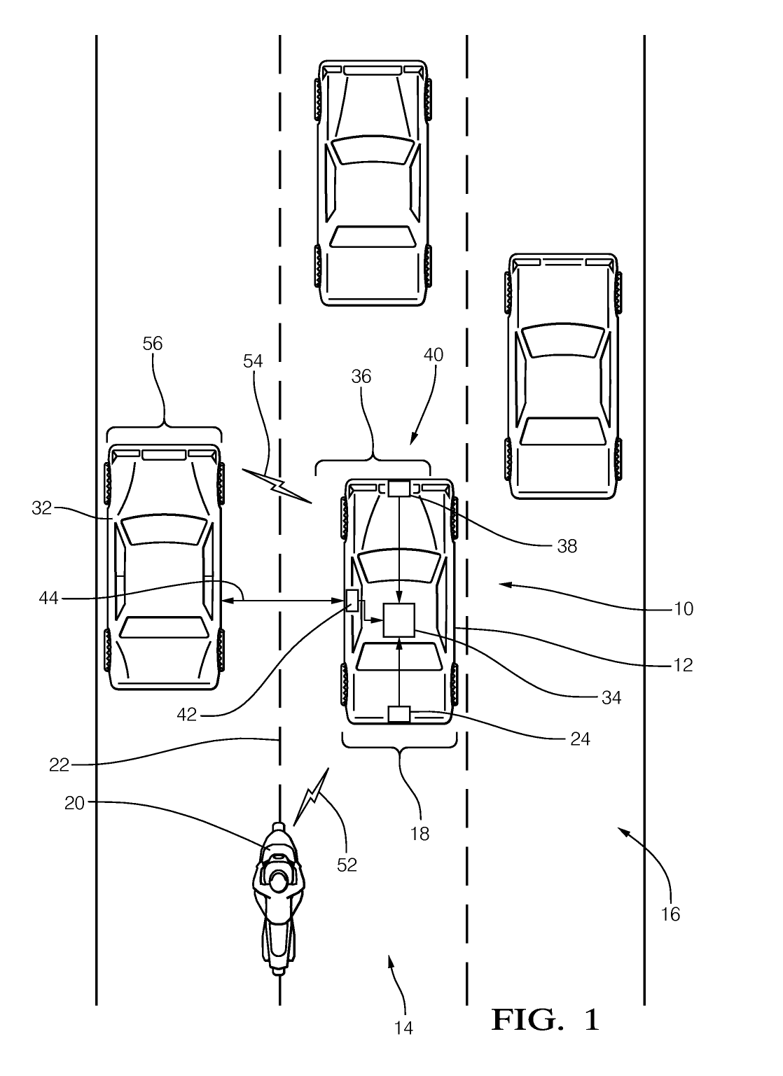

FIG. 1 illustrates a non-limiting example of a system 10 installed in a host-vehicle 12 for automated operation of the host-vehicle 12. Systems for fully automated operation of a vehicle have been proposed. The proposed systems control the speed, steering, brakes, and other aspects of vehicle operation necessary for the host-vehicle 12 to travel in a travel-lane 14 of a roadway 16 without interaction from an occupant (not shown) within the host-vehicle 12. While the improvements described herein are presented in the context of a fully automated vehicle, it is contemplated that the teachings presented herein could be applied to vehicles that are not automated or only partially automated, as will become apparent as the system 10 is described in more detail below.

Prior examples of automated vehicle systems generally tend to position the vehicle being controlled in a centered-position 36 of the selected travel-lane. As will also become apparent in the description that follows, an improvement provided by the system 10 described herein is that the system 10 steers the host-vehicle 12 to an off-center-position or an offset-position or a biased-position 18 selected to provide clearance for a motorcycle 20, bicycle, or other narrow-vehicle to pass the host-vehicle 12 while the motorcycle 20 is lane-splitting, i.e. traveling on or very near a lane-boundary 22 adjacent the host-vehicle 12. As such, in the following exemplary description, that only a motorcycle is described in any particular detail should not be viewed as a limitation of the system 10 that excludes bicycles or other narrow-vehicles.

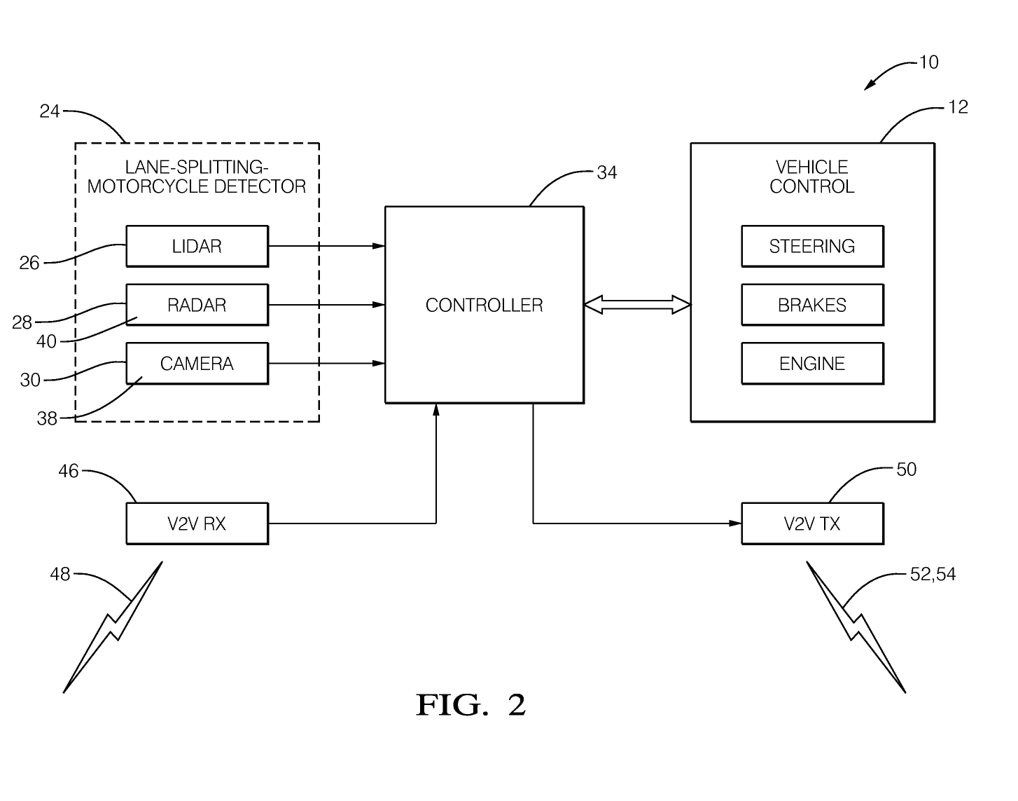

FIG. 2 further illustrates non-limiting details of the system 10. The system 10 includes a lane-splitting-motorcycle detector 24 configured to determine when the motorcycle 20 is proximate to a host-vehicle 12, and the motorcycle 20 is traveling proximate to the lane-boundary 22 that is adjacent the host-vehicle 12. The lane-splitting-motorcycle detector 24 may include, but is not limited to, one or more of a light detection and ranging device (lidar 26), a radar device (radar 28), and/or an image capture device (camera 30). Other devices suitable to detect an approaching motorcycle such as a microphone and an ultrasonic transceiver are also contemplated. While the modifier ‘motorcycle’ is used to modify ‘detector’, this should not be interpreted to mean that the lane-splitting-motorcycle detector 24 is limited to only detecting motorcycles. It is contemplated that the lane-splitting-motorcycle detector 24 may also be configured to detect other vehicles that may engage in lane-splitting such as bicycles or any other vehicle that may be narrow enough to reasonably engage in lane-splitting.

It is also contemplated that two or more of these devices may cooperate to detect and classify an approaching object as a motorcycle, bicycle, or other narrow-vehicle. For example, information from the radar 28 and the camera 30 may be combined to reliably detect the motorcycle 20. The lidar 26 is thought to be preferable for determining that an object behind the host-vehicle 12 is a motorcycle, but advancements in radar and image processing of images captured by the camera are expected, so those devices may be preferable in the future. While the lane-splitting-motorcycle detector 24 is shown as being mounted at the rear of the host-vehicle 12, it is contemplated that the various devices may be distributed and/or duplicated at various locations about the host-vehicle 12. For example, the camera 30 or duplicates of the camera 30 may be located forward on the host-vehicle 12 so that the lane-boundary 22 and other boundaries of the roadway 16 can be detected. Similarly, the radar 28 or duplicates of the radar 28 may be mounted at each corner of the host-vehicle 12 so that, in addition to detecting the motorcycle 20, an adjacent-vehicle 32 (FIG. 1) can be detected.

The system 10 includes a controller 34 configured to, during automated operation of the host-vehicle 12, steer the host-vehicle 12 away from the lane-boundary 22 to the biased-position 18 selected to provide clearance for the motorcycle 20 to pass the host-vehicle 12 while the motorcycle 20 is lane-splitting. That is, the system 10 or the controller 34 will generally tend to position the host-vehicle 12 in the centered-position 36 of the travel-lane 14 when the lane-splitting-motorcycle detector 24 does not detect the motorcycle 20, but will position the host-vehicle 12 in the biased-position 18 at least when the motorcycle 20 is detected at the location shown in FIG. 2. The system 10 may also be configured to steer the host-vehicle 12 away from the lane-boundary 24 to some off-set position such as the biased-position 18 when an approaching motorcycle appears to have some intent to lane split. That way, when a motorcycle comes up directly behind the host-vehicle 12, the biasing of the position of the host-vehicle 12 can begin in anticipation of the motorcycle 20 engaging in lane-splitting before the motorcycle 20 is actually proximate to the lane-boundary 22, e.g. within one meter (1 m) of the lane-boundary 22.

The controller 34 may include a processor (not shown) such as a microprocessor or other control circuitry such as analog and/or digital control circuitry including an application specific integrated circuit (ASIC) for processing data as should be evident to those in the art. The controller 34 may include memory (not shown), including non-volatile memory, such as electrically erasable programmable read-only memory (EEPROM) for storing one or more routines, thresholds and captured data. The one or more routines may be executed by the processor to perform steps for determining if signals received by the controller 34 indicate that the motor-cycle 20 is proximate to the host-vehicle 12, e.g. within thirty meters (30 m) of the rear of the host-vehicle 12, and if the host-vehicle 12 should be in the centered-position 36, the biased-position, or some other position in the travel-lane 14.

The system 10 may also include a lane-position-detector 38, the function of which in this non-limiting example is provided by the camera 30. The lane-position-detector 38 is generally configured to determine a relative-position 40 of the host-vehicle 12 in a travel-lane 14 defined by the lane-boundary 22 or other markings/features of the roadway 16. Alternatively, the lane-position-detector 38 may use a navigation-device (i.e. GPS), or other known means to determining the relative-position 40 of the host-vehicle 12 in the travel-lane 14. The lane-position-detector 38 is then useful to the system 10 to verify that the host-vehicle 12 is actually in the biased-position 18 if that is the intent of the system 10. The lane-position-detector 38 is shown mounted at the front of the host-vehicle 12, but other locations such as on the roof of the host-vehicle 12 or with the passenger compartment and looking through the windshield of the host-vehicle 12 are also contemplated.

The system 10 may also include an adjacent-vehicle-detector 42, the function of which in this non-limiting example is provided by the radar 20. The adjacent-vehicle-detector 42 is generally configured to determine a distance 44 between the adjacent-vehicle 32 and the host-vehicle 12. If the adjacent-vehicle 32 is equipped with a system similar to the system 10 described herein, the adjacent-vehicle 32 may also be steered away from the lane-boundary 22 to make room for the motorcycle 20 to pass via lane-splitting. The controller 34 may also be configured to further select the biased-position 18 or some other offset for the relative-position 40 based on the distance 44. For example, if the host-vehicle 12 is equipped with an additional radar sensor on the other side (i.e. the right side) of the host-vehicle 12, the system may recognize that the right lane is empty and steer the host-vehicle 12 further away from the lane-boundary that the biased-position 18 to provide more room for the motorcycle 20 to pass, especially if the adjacent-vehicle 32 has not moved away from the lane-boundary 22.

The system 10 may also include a vehicle-to-vehicle transmitter (V2V transmitter 46) configured to transmit a host-signal 48 that indicates that the host-vehicle is in the biased-position 18. A suitable example of vehicle-to-vehicle communication includes, but is not limited to, a Dedicated Short Range Communications system (DSRC) that uses the known 802.11P communication protocol. Such information may useful to other automated vehicles on the roadway 18 that adjust their relative positions based on the relative position 40 of the host vehicle. Alternatively, the V2V transmitter 46 may be configured to transmit a host-signal that indicates that the motorcycle is lane-splitting. Such information may be useful to other automated vehicles on the roadway 18 to anticipate the presence of the motorcycle 20 even though the other automated vehicles can't detect the motorcycle 40 directly because the field-of-view to the motorcycle 20 is blocked by another vehicle.

The system 10 may also include a vehicle-to-vehicle receiver (V2V receiver 50) configured to receive a lane-splitting-signal 52 from the motorcycle 20 that indicates that the motorcycle 20 is lane-splitting. The lane-splitting-signal 52 broadcast by the motorcycle may also include GPS or other location information so the system 10 can determine where the motorcycle 20 is located relative to the host-vehicle 12. The V2V receiver 50 may also be configured to receive an adjacent-signal 54 from the adjacent-vehicle 32 that indicates that the adjacent-vehicle 52 is in an adjacent-biased-position 56, has detected the motorcycle 20, or a combination thereof.

Accordingly, a system 10 for automated operation of the host-vehicle 12, and a controller 34 for the system 10 is provided. The system 10 and the controller 34 advance the automated vehicle arts by enabling the system 10 or the controller 34 to determine if or when the host-vehicle 12 should move out of the centered-position 36 in the travel-lane 14 to the biased-position 18 or some other off-center position to allow room for the motorcycle 20, a bicycle, or other narrow-vehicle to pass the host-vehicle 12 when the motorcycle 20, bicycle, or other narrow-vehicle is engaged in lane-splitting.

While this invention has been described in terms of the preferred embodiments thereof, it is not intended to be so limited, but rather only to the extent set forth in the claims that follow.

We claim:

1. A system for automated operation of a host-vehicle, said system comprising:
a lane-splitting-motorcycle detector configured to determine when a motorcycle proximate to a host-vehicle is traveling proximate to a lane-boundary adjacent the host-vehicle; and
a controller configured to, during automated operation, steer the host-vehicle away from the lane-boundary to a biased-position selected to provide clearance for the motorcycle to pass the host-vehicle while the motorcycle is lane-splitting.

2. The system in accordance with claim 1, wherein the system includes a lane-position-detector configured to determine a relative-position of the host-vehicle in a travel-lane defined by the lane-boundary.

3. The system in accordance with claim 1, wherein the system includes an adjacent-vehicle-detector configured to determine a distance between an adjacent-vehicle and the host-vehicle, and the controller is configured to further select the biased-position based on the distance.

4. The system in accordance with claim 1, wherein the system includes a vehicle-to-vehicle transmitter (V2V transmitter) configured to transmit a host-signal that indicates that the host-vehicle is in the biased-position.

5. The system in accordance with claim 1, wherein the system includes a vehicle-to-vehicle transmitter (V2V transmitter) configured to transmit a host-signal that indicates that the motorcycle is lane-splitting.

6. The system in accordance with claim 1, wherein the system includes a vehicle-to-vehicle receiver (V2V receiver) configured to receive a lane-splitting-signal from the motorcycle that indicates that the motorcycle is lane-splitting.

7. The system in accordance with claim 1, wherein the system includes a vehicle-to-vehicle receiver (V2V receiver) configured to receive an adjacent-signal from an adjacent-vehicle that indicates that the adjacent-vehicle is in an adjacent-biased-position.
